(19) United States
(12) Patent Application Publication
(10) Pub. No.: US 2003/0174350 A1
(43) Pub. Date: Sep. 18, 2003

(54) Color signal processing device capable of storing a color gamut efficiently and a method using the same

(75) Inventors: Moon-Cheol Kim, Suwon-City (KR); Jae-Hwan Ho, Suwon-City (KR); Seung-Joon Yang, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/352,942

(22) Filed: Jan. 29, 2003

(30) Foreign Application Priority Data
Mar. 13, 2002 (JP) 2002-13582

(51) Int. Cl. G06F 15/00; B41J 1/00

(52) U.S. Cl. 358/1.9

(57) ABSTRACT

A color signal processing device and method includes a calculating unit, a coordinate storing unit, a color gamut determining unit, and a signal processing unit. The calculating unit calculates brightness, chroma, and hue of an input RGB color signal. The coordinate storing unit stores a predetermined coordinate having the brightness and the chroma with respect to a color categorized in accordance with a predetermined level. The color gamut determining unit determines a color gamut to display the input RGB color signal. The signal processing unit digitizes the input RGB color signal within the determined color gamut. The color gamut determining unit extracts from the coordinate storing unit a coordinate corresponding to the calculated hue, and determines a range of displayable brightness and chroma based on the calculated brightness and the chroma, and the extracted coordinate.

### CROSS-REFERENCE TO RELATED APPLICATIONS

This application claims the priority of Korean Patent Application No. 2002-13582, filed Mar. 13, 2002 in the Korean Intellectual Property Office, the disclosure of which is incorporated herein by reference.

### BACKGROUND OF THE INVENTION

1. Field of the Invention

The present invention generally relates to an apparatus to process a color signal input to a display and a method using the same, and more particularly, to an apparatus to process a color signal capable of efficiently storing a color gamut for color signal processing and using the stored color gamut, and a method using the same.

2. Description of the Related Art

Generally, a color of an object shown as a result of light permeation, absorption, or reflection is generally called a “substantial color”. The substantial color is categorized into an achromatic color such as white, gray, and black, and a chromatic color such as red and blue.

Meanwhile, white is bright, black is dark, and gray is in the middle, which is due to brightness of each color. The brightness of each color is a measure of an intensity of a reflection light from the object and is represented in measurable units. The chromatic colors also have the brightness for example, melon yellow is bright and grape purple is dark.

Feelings that a human perceives about the reflected lights of various waves reflected from an object, i.e., in colors such as red, yellow, green, blue and purple, can be defined as “hue”. For example, waves between 430 and 480 nm are perceived somewhat bluish. Yellowish feelings are perceived in ranges between 570 and 600 nm, while the waves above 610 nm are felt as reddish. Achromatic colors such as black, gray, and white do have color, but cannot be said to have the hue.

The concentration of the color, i.e., the degree of non-dilution by white, is called “chroma.” Chroma usually shows the purity of color. A color of low chroma is expressed dim and vague, while the color of a high chroma is represented clear and lively. While the chromatic colors have hue, brightness, and chroma, the achromatic colors are somewhat different. That is, the achromatic colors have brightness, but they do not have hue and chroma.

A method to express a relation of a certain color with respect to other colors is called a color space (or, color model). Different image processing systems use different color models for different reasons. For example, a publishing company uses a CMY color space for publication of color pictures. A color cathode ray tube (CRT) monitor and computer graph systems use an RGB color space. Systems dealing with each of the hue, chroma, and brightness use an HIS color space. For the JPEG file interchange format, a YCbCr color space is used.

The RGB color space includes three primary colors combinable with one another, i.e., red, green, and blue. The primary colors are combined with one another in various proportion, resulting in different colors. As shown in FIG. 1, the RGB color space is represented as a 3-dimensional cube having vertices at respective axes for red, green, and blue. Here, black color is origin. White color is at an opposite end of the black color. Brightness is represented as the line starting from the black to the white. In the 24-bit color graphic system having 8 bits for each color channel, red color is expressed by (255, 0, 0). On the color cube, the red is expressed as (1, 0, 0).

YCbCr is another color space to particularly show the brightness among the color information. The brightness is symbolized as Y, and the blue color information and red color information are symbolized as CbCr. Y denotes the brightness information, while Cb and Cr denote a color scale. RGB is converted into YCbCr by the following expression:

(Mathematical Expression 1)

Y=0.29900 R+0.58700 G+0.11400 B

Cb=−0.16874 R−0.33126 G+0.50000 B

24 Cr=0.50000 R−0.41869G−0.08131 B

An inverse conversion, i.e., conversion from YCbCr into RGB is expressed by the following expression:

(Mathematical Expression 2)

R=1.00000 Y+1.40200 Cr

G=1.00000 Y−0.34414 Cb−0.71414 Cr

B=1.00000 Y+1.77200 Cb

FIG. 2 shows the color gamut of the colors of the RGB color space being expressed in the YCbCr space after the conversions by the above mathematical expressions 1 and 2.

Both mathematical expressions 1 and 2 are recommendations 601-1 by the International Radio Consultative Committee (CCIR), and typically used in the Joint Photographic Experts Group (JPEG) compression. In addition to the mathematical expressions 1 and 2, various conversions are also available.

A digital component converts and expresses the incoming RGB color signals as YCbCr color signals. Further, after digital signal processing, the YCbCr color signals are converted and displayed as RGB color signals on a display.

During a digital signal processing for color signal conversion from RGB to YCbCr, sometimes the colors, after the conversion, cannot be shown in the RGB color space. Accordingly, the processed color signal can be inordinate of the color gamut shown by the display.

### SUMMARY OF THE INVENTION

Various aspects and advantages of the invention will be set forth in part in the description that follows and, in part, will be obvious from the description, or may be learned by practice of the invention.

Accordingly, according to an aspect of the present invention, there is provided a color signal processing apparatus capable of efficiently storing information about a color gamut and using the stored color gamut such that a result of digital signal processing with respect to color signals can be represented in an expressible color gamut, and a method of using the same.

According to an aspect of the present invention, a color signal processing device, includes a calculating unit calculating brightness, chroma, and hue of an input RGB color signal; a coordinate storing unit storing a predetermined coordinate including the brightness and the chroma with respect to a color categorized in accordance with a predetermined level; a color gamut determining unit determining a color gamut to display the input RGB color signal; and a signal processing unit digitizing the input RGB color signal within the determined color gamut. The color gamut determining unit extracts from the coordinate storing unit a coordinate corresponding to a calculated color, and determines a range of displayable brightness and chroma based on the calculated brightness and the chroma, and the extracted coordinate. The signal processing unit digitizes the input RGB color signal when the input RGB color signal exists within the color gamut determined by the color gamut determining unit.

The calculating unit calculates the chroma and the hue by,

$$\begin{matrix}C = \sqrt{{Cb}^{2} + {Cr}^{2}} \\ H = {tan}^{- 1} \frac{Cb}{Cr}\end{matrix}$$

where, C is the chroma, Cb is a color scale representing a green color, Cr is a color scale representing a reddish color, and H is the hue.

The color gamut determining unit determines a maximum chroma with respect to a triangle that is constructed using the coordinate extracted from the coordinate storing unit and an axis of the brightness representing a shift of the brightness, by,

Y:Yₚₒₛ=Cₘₐₓ:Cₚₒₛ (for Y≦Yₚₒₛ)

(255−Y):(255−Yₚₒₛ)=Cₘₐₓ:Cₚₒₛ (for Y>Yₚₒₛ)

Yₚₒₛ is a brightness value of the coordinate, Y is the brightness of the input RGB color signal, Cₚₒₛ is a chroma value of the coordinate, and Cₘₐₓ is a maximum chroma that is raised to a range that maintains the brightness and the hue of the input RGB color signal.

The color gamut determining unit determines the range of the brightness with respect to a triangle that is constructed using the coordinate extracted from the coordinate storing unit and the axis of the brightness representing a shift of the brightness, by,

Yₘᵢₙ:Yₚₒₛ=C:Cₚₒₛ

(255−Yₘₐₓ):(255−Yₚₒₛ)=C:Cₚₒₛ

Yₚₒₛ is the brightness value of the coordinate, Y is the brightness of the input RGB color signal, C is the chroma of the RGB color signal, Yₘᵢₙ is a minimum brightness that is lowered within a range that maintains the hue and the chroma of the input RGB color signal, and Yₘₐₓ is a maximum brightness that is raised within the range that maintains the hue and the chroma of the input RGB color signal.

According to an aspect of the present invention, there is provided a color signal processing device, including a calculating unit calculating brightness, chroma, and hue of an input color signal; and a coordinate storing unit storing a coordinate of vertices of a triangle, which is constructed by a maximum chroma and an axis of the brightness for each color categorized in accordance with a predetermined level, wherein the maximum chroma is raised within a range to maintain the brightness and the hue of the input color signal and the axis of the brightness represents a shift of the brightness.

Accordingly, as the displayable color gamut is correctly selected for the input RGB color signal, the information about color gamut can be utilized in a process of digital signal processing, and a result obtained after the processing is prevented from exceeding the displayable color gamut.

Meanwhile, according to an aspect of the present invention, a color signal processing method is provided, which includes: calculating brightness, chroma, and hue of an input RGB color signal; retrieving a coordinate corresponding to the calculated hue; determining a displayable color gamut based on the extracted coordinate and the calculated brightness and the chroma; displaying the input RGB color signal; and digitizing the input RGB color signal within the determined color gamut. The retrieving of the coordinate extracts the coordinate corresponding to the calculated hue, and determines a displayable range of the brightness and the chroma based on the calculated brightness and the chroma and the extracted coordinate.

According to an aspect of the present invention, there is provided a coordinate corresponding to a calculated hue, and determining the range of displayable brightness and chroma based on a calculated brightness and chroma. As a result, a color gamut to process a color signal can be efficiently stored and utilized.

According to an aspect of the present invention, there is provided a color signal processing method including calculating brightness, chroma, and hue of an input color signal; and storing a coordinate of vertices of a triangle, which is constructed by a maximum chroma and an axis of the brightness for each color categorized in accordance with a predetermined level, wherein the maximum chroma can be raised within a range that maintains the brightness and the hue of the input color signal, and the axis of the brightness represents a shift of the brightness.

### BRIEF DESCRIPTION OF THE DRAWINGS

(The above-mentioned object and the feature of the present invention will be more apparent by describing the preferred embodiment of the present invention by referring to the appended drawings, in which) These and other aspects and/or advantages of the invention will become apparent and more readily appreciated from the following description of the embodiments, taken in conjunction with the accompanying drawings of which:

FIG. 1 is a view showing an RGB color space;

FIG. 2 is a view showing a color gamut of the RGB color space being represented in a YCbCr color space;

FIG. 3 is a view showing a projection of the color gamut of FIG. 2 in a CbCr color space;

FIG. 4 is a block diagram schematically showing a color signal processing device, according to an aspect of the present invention;

FIG. 5 is a flowchart showing a color signal processing by the color signal processing device of FIG. 4;

FIG. 6 is a view showing a method of determining the color gamut according to a hue;

FIG. 7 is a view showing a method of determining the color gamut according to a certain hue of FIG. 6;

FIG. 8 is a view showing an example of a method of obtaining a range of chroma;

FIG. 9 is a view showing an example of a method of obtaining a range of brightness; and

FIG. 10 is a view showing another example of a method of obtaining a range of the chroma.

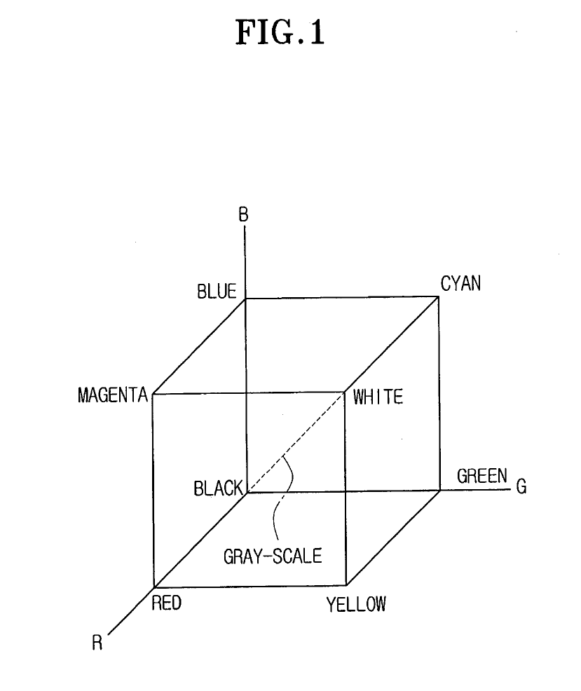

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

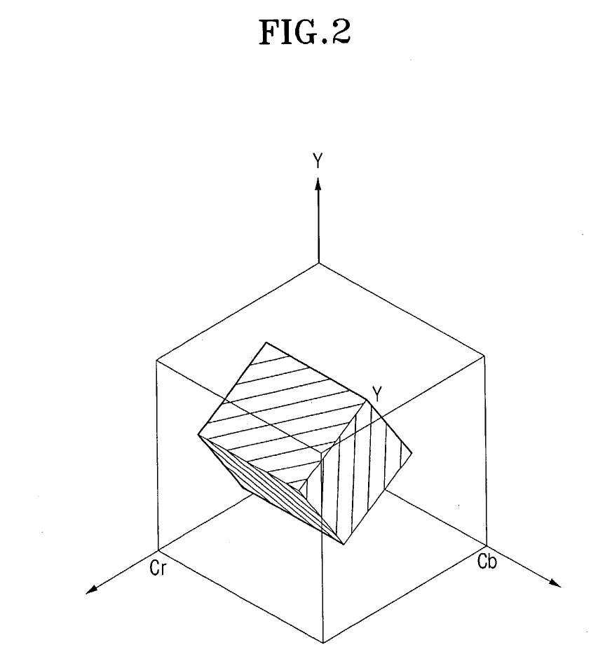

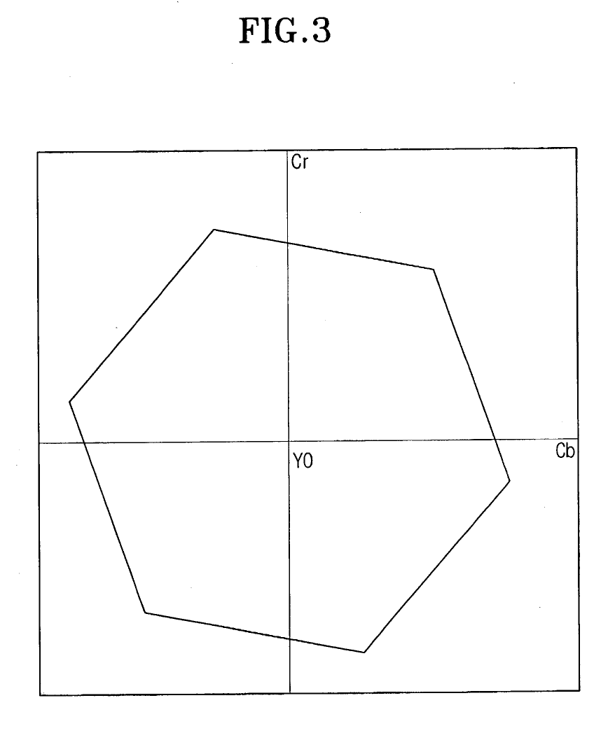

FIG. 3 shows a projection of FIG. 2 into a CbCr color space. According to an aspect of the present invention, a color gamut of a YCbCr color space is expressed in the CbCr color space with Y=0. The CbCr color space is expressed as a polar coordinate system as shown in the following mathematical expression 3.

(Mathematical Expression 3)

$$\begin{matrix}C = \sqrt{{Cb}^{2} + {Cr}^{2}} \\ H = {tan}^{- 1} \frac{Cb}{Cr}\end{matrix}$$

A color space expressed by the mathematical expression 3 is a YCH color space. It is possible to convert and express the color gamut of the YCbCr color space in the YCH color space.

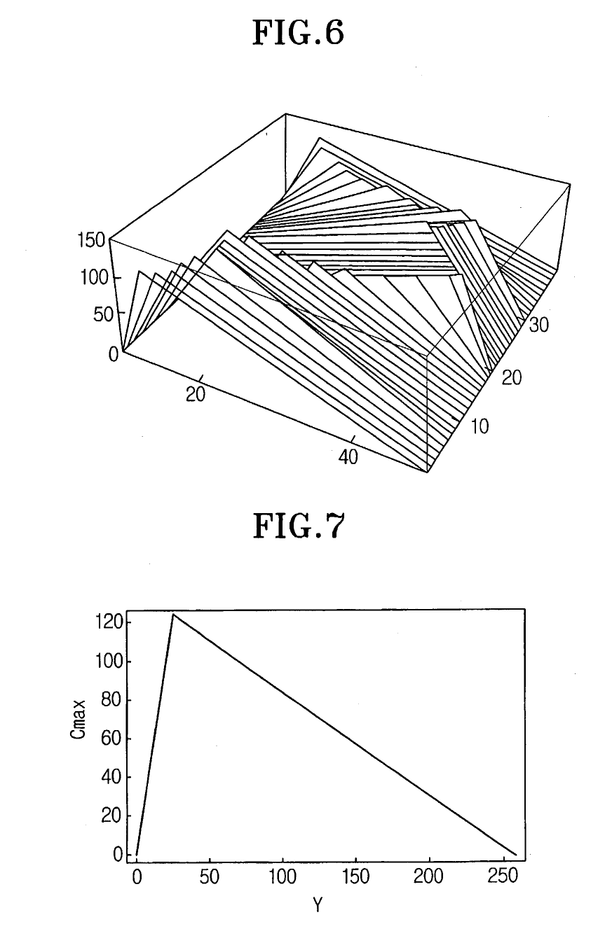

FIG. 6 shows Y and C values included in the color gamut, which can be processed in accordance with a respective hue. Re-drawing of the Y and C values in accordance with a color value H is shown in FIG. 7.

As shown in FIG. 7, with a single hue H, the values Y and C in the color gamut are located inside of a single triangle. Accordingly, the color gamut of a given value, i.e., the color value of the single hue H, can be calculated using vertex values of the triangle.

Therefore, when storing color gamut information, three vertices can be stored instead of the entire color gamut. Further, because one (Y=0, Cₘₐₓ=0) and the other vertex (Y=255, Cₘₐₓ=0) of the triangle are common, only a last vertex can be stored. The last vertex may be denoted as (Y=Yₚₒₛ, C=Cₚₒₛ). Simply by storing the vertex value of (Yₚₒₛ(H), Cₚₒₛ(H)) in accordance with the given color value of the single hue H, the color gamut information can be obtained.

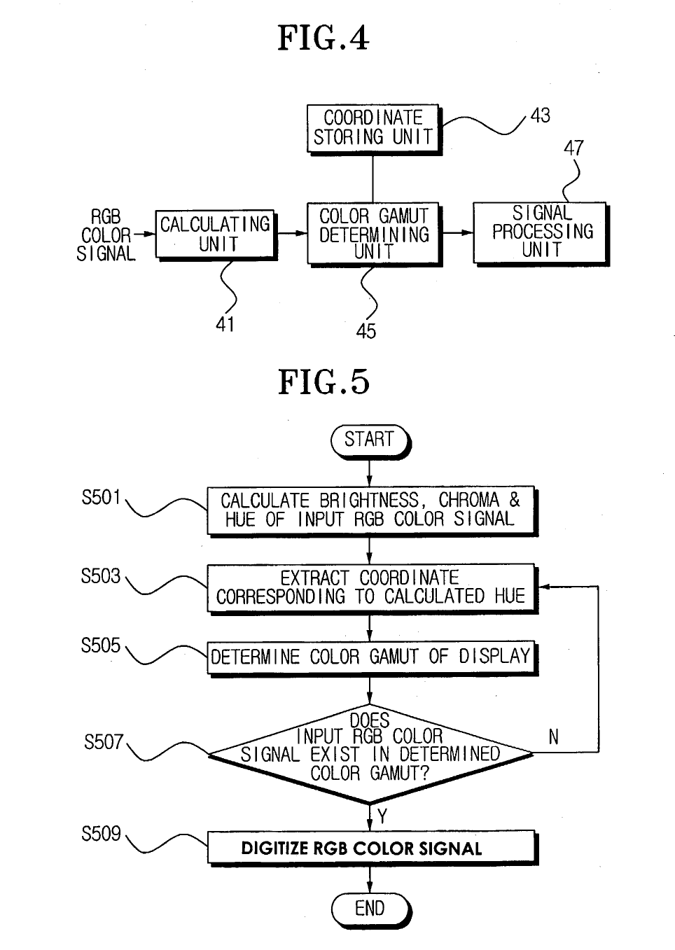

FIG. 4 is a block diagram schematically showing a color signal processing device, according to an aspect of the present invention. Referring to FIG. 4, the color signal processing device includes a calculating unit 41, a coordinate storing unit 43, a color gamut determining unit 45 and a signal processing unit 47.

The calculating unit 41 calculates brightness, chroma, and hue corresponding to an input RGB color signal. Brightness Y corresponding to the input RGB color signal can be obtained by Y=0.29900 R+0.58700 G+0.11400 B as shown in the mathematical expression 1 in the Background of the Invention section. Further, the chroma C and the hue H can be calculated by the mathematical expression 3, based on bluish information Cb and reddish information Cr obtained by the mathematical expression 1.

The coordinate storing unit 43 stores a coordinate value including the brightness and the chroma of each color categorized according to predetermined levels, namely, the value (Yₚₒₛ(H), Cₚₒₛ(H)).

The color gamut determining unit 45 determines the color gamut of a display (not shown) that displays the input RGB color signals. The color gamut determining unit 45 extracts from the coordinate storing unit 43 the coordinate corresponding to a calculated color by the calculating unit 41, and determines a displayable range of the brightness and the chroma of the display based on the extracted coordinate and the brightness and the chroma calculated by the calculating unit 41.

The signal processing unit 47 digitizes the input RGB color signals within the color gamut determined by the color gamut determining unit 45, and converts and outputs the digitalized color signals on the display as the RGB color signals.

FIG. 5 is a flowchart showing a method of color signal processing of FIG. 4. Referring to FIG. 5, at operation S501, the calculating unit 41 calculates the brightness, the chroma, and the hue of the input RGB color signals using mathematical expressions 1 and 3. The calculated brightness, the chroma and the hue of the RGB color signals are transmitted to the color gamut determining unit 45.

At operation S503, the color gamut determining unit 45 extracts from the coordinate storing unit 43 coordinates corresponding to the brightness, the chroma, and the hue calculated by the calculating unit 41. The coordinate storing unit 43 stores the coordinates including the brightness and the chroma of each color that is categorized in accordance with an angle at predetermined intervals. The respective coordinate values stored in the coordinate storing unit 43 construct a single triangle in cooperation with the axis of brightness. An axis of the brightness represents shifts of the brightness. FIG. 6 shows triangles constructed using the method of FIG. 5.

FIG. 7 representatively shows such a triangle. Although FIG. 6 shows the single coordinate corresponding to each hue by way of an example, this must not be considered as limiting. For example, the coordinate storing unit 43 can store a plurality of coordinates corresponding to each hue.

At operation S505, the color gamut determining unit 45 determines the color gamut of the display based on the triangle (see FIG. 7) formed by the extracted coordinates and the axis of the brightness.

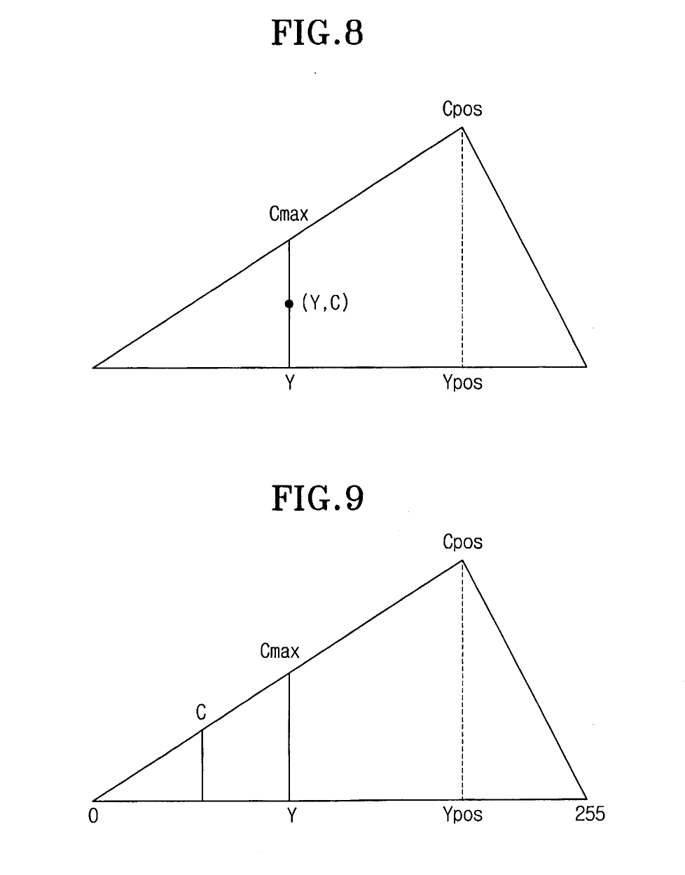

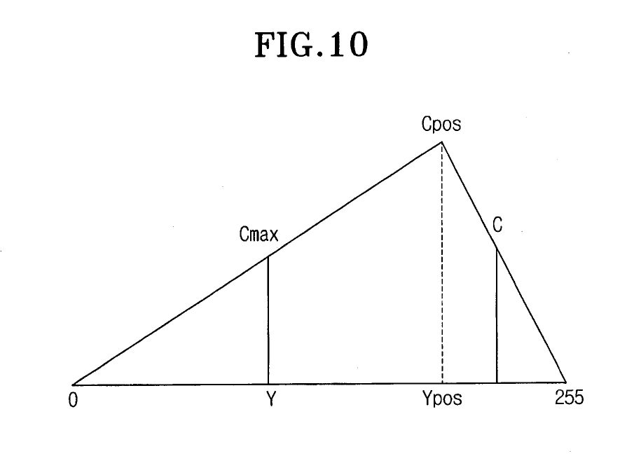

FIGS. 8 through 10 show a method of determining the color gamut of the display based on the triangle formed by the extracted coordinates and the axis of the brightness. Referring to the drawings, a maximum chroma with respect to the triangle formed by the cooperation of the coordinates from the coordinate storing unit 43 and the axis of the brightness is determined by the following expression:

(Mathematical Expression 4)

Y:Yₚₒₛ=Cₘₐₓ:Cₚₒₛ (for Y≦Yₚₒₛ)

(255−Y):(255−Yₚₒₛ)=Cₘₐₓ:Cₚₒₛ (for Y>Yₚₒₛ)

Where Cₚₒₛ is the chroma value of the coordinate, and Cₘₐₓ is the maximum chroma within a range that maintains the brightness and the hue of the input RGB color signal. Because a minimum chroma value begins from “0” according to an aspect of the present invention, only the maximum chroma value needs to be obtained.

With respect to the triangle formed by the coordinates extracted from the coordinate storing unit 43 and the axis of brightness, the range of brightness can be determined by,

(Mathematical expression 5)

Yₘᵢₙ:Yₚₒₛ=C:Cₚₒₛ

(255−Yₘₐₓ):(255−Yₚₒₛ)=C:Cₚₒₛ

where, Yₚₒₛ is the brightness value of the coordinate, Y is the brightness of the input RGB color signal, C is the chroma of the RGB color signal, Yₘᵢₙ is the minimum brightness that can be lowered within the range that maintains the hue and the chroma of the RGB color signal, and Yₘₐₓ is the maximum brightness that can be raised within the range that maintains the hue and the chroma of the input RGB color signal.

At operation S507, the color gamut determining unit 45 determines whether the coordinate of the brightness and the chroma of the input RGB color signal exists within the determined color gamut. If the coordinate of the brightness and the chroma of the input RGB color signal does not exist within the determined color gamut, the color gamut determining unit 45 extracts a new coordinate from the coordinate storing unit 43, and repeats the method thereafter.

If the coordinate of the brightness and the chroma of the input RGB color signal exists within the determined color gamut, the color gamut determining unit 45 transmits the determined display color gamut to the signal processing unit 47. At operation S509, the signal processing unit 47 digitizes the input RGB color signals in accordance with the color gamut received from the color gamut determining unit 45.

As described above, the color signal processing device only needs to store a predetermined coordinate to determine the display color gamut. Accordingly, an amount of memory capacity is greatly reduced.

With a color signal processing device, according to an aspect of the present invention, a storage capacity of a memory to store a color gamut is less than the storage capacity required by conventional memory units, and information about the color gamut is used in color signal processing. Further, the information about the color gamut can be used to prevent a result of color signal processing from exceeding a displayable color gamut.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A color signal processing device, comprising:
a calculating unit calculating brightness, chroma, and hue of an input RGB color signal;
a coordinate storing unit storing a predetermined coordinate having the brightness and the chroma with respect to a color categorized in accordance with a predetermined level;
a color gamut determining unit determining a color gamut to display the input RGB color signal; and
a signal processing unit digitizing the input RGB color signal within the determined color gamut, wherein
the color gamut determining unit extracts from the coordinate storing unit a coordinate corresponding to the calculated hue, and determines a range of displayable brightness and chroma based on the calculated brightness and the chroma, and the extracted coordinate.

2. The color signal processing device of claim 1, wherein the signal processing unit digitizes the input RGB color signal when the input RGB color signal exists within the color gamut determined by the color gamut determining unit.

3. The color signal processing device of claim 2, wherein the calculating unit calculates the chroma and the hue by,
$$\begin{matrix}C = \sqrt{{Cb}^{2} + {Cr}^{2}} \\ H = {tan}^{- 1} \frac{Cb}{Cr}\end{matrix}$$
where, C is the chroma, Cb is a color scale representing a green color, Cr is a color scale representing a reddish color, and H is the hue.

4. The color signal processing device of claim 3, wherein the color gamut determining unit determines a maximum chroma with respect to a triangle that is constructed using the coordinate extracted from the coordinate storing unit and an axis of the brightness representing a shift of the brightness, by,
Y:Yₚₒₛ=Cₘₐₓ:Cₚₒₛ (for Y≦Yₚₒₛ)
(255−Y):(255−Yₚₒₛ)=Cₘₐₓ:Cₚₒₛ (for Y>Yₚₒₛ)
where, Yₚₒₛ is a brightness value of the coordinate, Y is the brightness of the input RGB color signal, Cₚₒₛ is a chroma value of the coordinate, and Cₘₐₓ is a maximum chroma that is raised to a range that maintains the brightness and the hue of the input RGB color signal.

5. The color signal processing device of claim 3, wherein the color gamut determining unit determines the range of the brightness with respect to a triangle that is constructed using the coordinate extracted from the coordinate storing unit and an axis of the brightness representing a shift of the brightness, by,
Yₘᵢₙ:Yₚₒₛ=C:Cₚₒₛ
(255−Yₘₐₓ):(255−Yₚₒₛ)=C:Cₚₒₛ
where, Yₚₒₛ is a brightness value of the coordinate, Y is the brightness of the input RGB color signal, C is the chroma of the RGB color signal, Yₘᵢₙ is a minimum brightness that is lowered within a range that maintains the hue and the chroma of the input RGB color signal, and Yₘₐₓ is a maximum brightness that is raised within the range that maintains the hue and the chroma of the input RGB color signal.

6. A color signal processing device, comprising:
a calculating unit calculating brightness, chroma, and hue of an input color signal; and
a coordinate storing unit storing a coordinate of vertices of a triangle, which is constructed by a maximum chroma and an axis of the brightness for each color categorized in accordance with a predetermined level, wherein the maximum chroma is raised within a range to maintain the brightness and the hue of the input color signal and the axis of the brightness represents a shift of the brightness.

7. A color signal processing method, comprising:
calculating brightness, chroma, and hue of an input RGB color signal;
retrieving a coordinate corresponding to the calculated hue;
determining a displayable color gamut based on the extracted coordinate and the calculated brightness and the chroma;
displaying the input RGB color signal;
digitizing the input RGB color signal within the determined color gamut; and
storing a predetermined coordinate comprising the brightness and the chroma of a color categorized in accordance with a predetermined level.

8. The color signal processing method of claim 7, wherein the input RGB color signal is digitized when the input RGB color signal exists within the determined color gamut.

9. The color signal processing method of claim 8, wherein the chroma and the hue are calculated using,
$$\begin{matrix}C = \sqrt{{Cb}^{2} + {Cr}^{2}} \\ H = {tan}^{- 1} \frac{Cb}{Cr}\end{matrix}$$
where, C is the chroma, Cb is a color scale representing a green color, Cr is a color scale representing a reddish color, and H is the hue.

10. The color signal processing method of claim 9, further comprising:
determining a maximum chroma with respect to a triangle that is constructed using the coordinate extracted and an axis of the brightness representing the shift of the brightness, by,
Y:Yₚₒₛ=Cₘₐₓ:Cₚₒₛ (for Y≦Yₚₒₛ)
(255−Y):(255−Yₚₒₛ)=Cₘₐₓ:Cₚₒₛ (for Y>Yₚₒₛ)
where, Yₚₒₛ is a brightness value of the coordinate, Y is the brightness of the input RGB color signal, Cₚₒₛ is a chroma value of the coordinate, and Cₘₐₓ is a maximum chroma that is raised to a range that maintains the brightness and the hue of the input RGB color signal.

11. The color signal processing method of claim 9, wherein the determining unit determines the range of the brightness with respect to a triangle that is constructed using the coordinate extracted from the coordinate storing unit and an axis of the brightness representing a shift of the brightness, by,
Yₘᵢₙ:Yₚₒₛ=C:Cₚₒₛ
(255−Yₘₐₓ):(255−Yₚₒₛ)=C:Cₚₒₛ
where, Yₚₒₛ is a brightness value of the coordinate, Y is the brightness of the input RGB color signal, C is the chroma of the RGB color signal, Yₘᵢₙ is a minimum brightness that is lowered within the range that maintains the hue and the chroma of the input RGB color signal, and Yₘₐₓ is a maximum brightness that is raised within the range that maintains the hue and the chroma of the input RGB color signal.

12. A color signal processing method, comprising:
calculating brightness, chroma, and hue of an input color signal; and
storing a coordinate of vertices of a triangle, which is constructed by a maximum chroma and an axis of the brightness for each color categorized in accordance with a predetermined level, wherein the maximum chroma is raised within a range to maintain the brightness and the hue of the input color signal and the axis of the brightness represents a shift of the brightness.

13. The color signal processing device of claim 1, wherein the calculating unit calculates the brightness corresponding to the input RGB color signal by a following relationship:
Y=0.29900 R+0.58700 G+0.11400 B.

14. The color signal processing device of claim 1, wherein the information about the color gamut prevents a result of color signal processing from exceeding a displayable color gamut.
